(19) United States
(12) Patent Application Publication
(10) Pub. No.: US 2013/0212081 A1
(43) Pub. Date: Aug. 15, 2013

(54) IDENTIFYING ADDITIONAL DOCUMENTS RELATED TO AN ENTITY IN AN ENTITY GRAPH

(71) Applicants: RAJESH KRISHNA SHENOY, SAN JOSE, CA (US); CHARLES C. CARSON, JR., CUPERTINO, CA (US); YI-AN LIN, SUNNYVALE, CA (US); TIMOTHY ANDREW HARRINGTON, MOUNTAIN VIEW, CA (US); SAMEER INDARAPU, MOUNTAIN VIEW, CA (US)

(72) Inventors: RAJESH KRISHNA SHENOY, SAN JOSE, CA (US); CHARLES C. CARSON, JR., CUPERTINO, CA (US); YI-AN LIN, SUNNYVALE, CA (US); TIMOTHY ANDREW HARRINGTON, MOUNTAIN VIEW, CA (US); SAMEER INDARAPU, MOUNTAIN VIEW, CA (US)

(73) Assignee: MICROSOFT CORPORATION, REDMOND, WA (US)

(21) Appl. No.: 13/371,740

(22) Filed: Feb. 13, 2012

(51) Int. Cl. G06F 17/30

(52) U.S. Cl. 707/706; 707/798; 707/769; 707/E17.108; 707/E17.011

(57) ABSTRACT

Systems, computer-readable media, and methods for tagging documents based on a graph pertaining to one or more entities which a user has included in a search query. The user may have at least one social networking relationship with the entity. A search engine is configured to display a search engine results page in response to the search query received from the user. The search engine may also receive suggested tags that identify documents that could be linked to the entity identified in the query. The user may confirm that the suggested tags are appropriate via feedback that is transmitted to the search engine. In turn, the search engine updates a graph to reflect a number of users that agree with the suggested tag.

### BACKGROUND

Conventional search engines provide users with access to a vast amount of information, typically located on the Internet. The Internet consists of billions of content items, including web pages and other multimedia content interconnected by hypertext links, which allow users to navigate among the web pages. In order to find desired content, computer users often make use of search engines to query an index for one or more search terms. The computer users provide search terms to a conventional search engine, which returns results that refer to the web pages and other electronic content that match the search terms. Unfortunately, a significant set of search terms received from the users are ambiguous. Typical examples are search terms that include names, e.g., “John Smith.”

A user may transmit a person search query to a conventional search engine, which locates content that contains information about search terms included in the search query. For instance, a search query for “John Smith” that is received by the conventional search engine is parsed into the search terms: “John” and “Smith” or “John” or “Smith.” The conventional search engines then perform searches of the index for each of the search terms: “John” and “Smith.” The results from the index that match the terms are provided to the user. However, the conventional search engine is unable to distinguish between multiple individuals within the search results that have the same name.

Some conventional search engines refine the results via query modifiers that are suggested to the user or obtained from the context of the user. For instance, location information associated with an Internet Protocol (IP) address of the user may be used to narrow the results' size by removing results that fail to match the location of the user. The conventional search engines may utilize other modifiers, e.g., prior search histories from the user or other users, to narrow the size of the results. The prior search histories included in a search log of the database may be analyzed by the conventional search engine. The search log may include modifiers that were previously used by the user or other searchers when searching for “John Smith.” The conventional search engine extracts the modifiers from the search log and presents them to the user as query modifiers that may narrow the size of results.

### SUMMARY

Embodiments of the invention relate to systems and methods for utilizing social network information pertaining to one or more individuals or entities with which a searcher has at least one predefined type of relationship to present relevant search results to the searcher in response to receiving a search query. A search engine is configured to utilize the social network information to infer additional documents that could be linked to an entity identified in the query. In turn, the search engine transmits ranked URLs in a search engine results page along with suggested tags that associate the additional documents with the entity.

In some embodiments, the suggested tags for the entity are reviewed by the searcher who provides feedback in response to a solicitation from the search engine. The search engine receives feedback from the searcher. The feedback may indicate whether the suggested tag is appropriate. If the feedback is positive, a graph associated with the entity is updated with the suggested tag to link the additional documents and the entity.

Embodiments of the invention are defined by the claims below, not this Summary. A high-level overview of various aspects of embodiments of the invention are provided here for that reason, to provide an overview of the disclosure, and to introduce a selection of concepts that are further described below. This Summary is not intended to identify key features or essential features of the claimed subject matter, nor is it intended to be used in isolation to determine the scope of the claimed subject matter.

### BRIEF DESCRIPTION OF THE SEVERAL VIEWS OF THE DRAWINGS

Illustrative embodiments of the invention are described in detail below with reference to the attached drawing figures, which are incorporated by reference in their entirety and wherein:

FIG. 1 is a network diagram that illustrates an exemplary computing system in accordance with embodiments of the invention;

FIG. 2 is a logic diagram illustrating an exemplary computer-implemented method for tagging documents, in accordance with embodiments of the invention;

FIG. 3 is a graphical user interface illustrating electronic documents provided in a search engine results page, in accordance with embodiments of the invention;

FIG. 4 is another logic diagram illustrating an exemplary computer-implemented method for tagging electronic documents, in accordance with embodiments of the invention; and

FIG. 5 is a component diagram illustrating an exemplary operating environment, in accordance with embodiments of the invention.

### DETAILED DESCRIPTION

The subject matter of this patent is described with specificity herein to meet statutory requirements. However, the description itself is not intended to necessarily limit the scope of claims. Rather, the claimed subject matter might be embodied in other ways to include different steps or combinations of steps similar to the ones described in this document, in conjunction with other present or future technologies. Although the terms “step,” “block,” and/or “component,” etc., might be used herein to connote different components of methods or systems employed, the terms should not be interpreted as implying any particular order among or between various steps herein disclosed unless and except when the order of individual steps is explicitly described.

Various aspects of the technology described herein are generally directed to computer systems, computer-implemented methods, and computer-readable storage media for, among other things, returning relevant URLs in a search engine results page when responding to a query. The URLs identify content, including multimedia content and electronic content. The URLs may be located based on available social networking data for a user or the search terms included in the user's query. Embodiments of the invention allow search engines to improve the relevance of search results prioritized for display to the user in response to a query by harnessing profile data from social networks, like Facebook® and Linkedin®.

In one embodiment, the search engine may generate a graph for storage in a database. The graph may include information from a social network of an entity or tags previously selected for association with the entity. The tags are associations made between entities and documents. The associations may be received directly from users or indirectly from the users via confirmation of suggested tags. The tags may be one or more documents based on input received from users searching for the entity. The graph may include nodes and edges. The nodes may represent the documents and entities and edges represent the tags and social network connections between entities.

The graph may be traversed, by a computing device, to identify additional documents that could be linked to one or more entities in the graph. In some embodiments, the computing device is the search engine. The computing device obtains the profile information and linked documents to identify additional documents that could be linked to the entity. The additional documents are associated with suggested tags that correspond to the entity. In turn, when a user enters a query for the entity, the search engine transmits a search engine results page with the previously linked documents, the additional documents, and the suggested tags.

The search engine, in some embodiments, solicits feedback from the user. The feedback is utilized to determine whether to store the suggested tags in the graph. The feedback may be received from multiple users that search for the entity. In turn, the search engine receives the feedback and may combine the feedback from multiple users to improve the quality of disambiguation. For instance, when several users agree that a document could be linked to the entity, the search engine has more confidence in the link between the entity and the document. In other embodiments, the users that are within the social network of the entity are allowed to provide feedback but users that are not within the social network of the entity are not.

The suggested tags help resolve contention associated with ambiguous entity names (two or more individuals with similar names) that are each associated with one or more of the same documents. The suggested tags and the graph may help resolve contention based on the social context of the user and the entity. The edges of the graph may be disambiguated based on user feedback or the social context of the entity. Additionally, other parts of the graph may also be disambiguated using an automated means without requiring user intervention. Furthermore, the social network of the user and entity may be utilized to prevent spam (e.g., associating an entity with undesirable content like porn, graphic material, violent content, etc.).

In other embodiments of the invention, the search engine may not have access to the searcher's social network. The search engine may receive a query and determine whether the query is classified as a name query. If the query is a name query, the search engine accesses an index of web pages and multimedia to generate a search engine results page. Also, the search engine may access the entity graph to locate entities having public profiles—in a social network—that match the query. The search engine selects index entries that match the query received from the searcher. In turn, the search engine clusters the matching index entries based on the graph having the public entities that match the query and the documents linked to the public entities within the graph. The clusters and the results are transmitted to the searcher for display on a computing device. Accordingly, the search engine may improve the searcher's experience when dealing with ambiguous name queries by clustering electronic documents based on public social network profile data.

As one skilled in the art will appreciate, the computer system may include hardware, software, or a combination of hardware and software. The hardware includes processors and memories configured to execute instructions stored in the memories. In one embodiment, the memories include computer-readable media that store a computer-program product having computer-useable instructions for a computer-implemented method. Computer-readable media include both volatile and nonvolatile media, removable and nonremovable media, and media readable by a database, a switch, and various other network devices. Network switches, routers, and related components are conventional in nature, as are means of communicating with the same. By way of example, and not limitation, computer-readable media comprise computer-storage media and communications media. Computer-storage media, or machine-readable media, include media implemented in any method or technology for storing information. Examples of stored information include computer-useable instructions, data structures, program modules, and other data representations. Computer-storage media include, but are not limited to, random access memory (RAM), read only memory (ROM), electrically erasable programmable read only memory (EEPROM), flash memory or other memory technology, compact-disc read only memory (CD-ROM), digital versatile discs (DVD), holographic media or other optical disc storage, magnetic cassettes, magnetic tape, magnetic disk storage, and other magnetic storage devices. These memory technologies can store data momentarily, temporarily, or permanently.

In yet another embodiment, the computer system includes a communication network having an index, entity graph based on a social network and previously tagged documents, client computers, and a search engine. The index is configured to store URLs for content located on the Internet. A user may generate a query at the computer, which is communicatively connected to the search engine. In turn, the computer may transmit the query and social network identifier of the user—if available—to the search engine. The search engine may use the query to locate URLs, in the index, having content that matches the query. The search engine may provide the URLs in a search engine results page, which may order the results based on the match to the query and matches between an entity in the entity graph and the query.

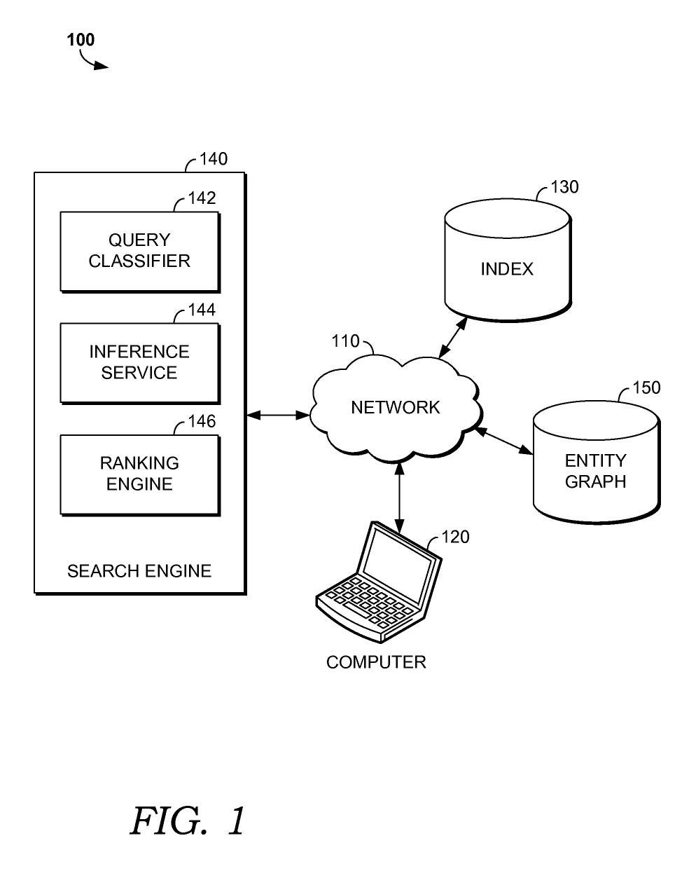

FIG. 1 is a network diagram that illustrates an exemplary computing system 100 in accordance with embodiments of the invention. The computing system 100 shown in FIG. 1 is merely exemplary and is not intended to suggest any limitation as to scope or functionality. Embodiments of the invention are operable with numerous other configurations. With reference to FIG. 1, the computing system 100 includes a network 110, computer 120, index 130, search engine 140, and entity graph 150 that includes a social network received from a social network provider.

The network 110 enables communication among the various network devices and resources. The network 110 connects computer 120 and search engine 140. The entity graph 150 and index 130 are also connected to network 110. The network 110 is configured to facilitate communication between the computer 120 and the search engine 140. It also enables the search engine 140 to access the entity graph 150 to obtain information based on URLs in a search engine results page and a social network identifier. In some embodiments, the social network identifier is associated with the user. The network 110 may be a communication network, such as a wireless network, local area network, wired network, or the Internet. In an embodiment, the computer 120 interacts with the search engine 140 utilizing the network 110. For instance, a user of the computer 120 may generate a query, like a name query. In response, the search engine 140 interrogates the index 130 for URLs that include web pages, images, videos, or other electronic documents that match the query generated by the user.

The computer 120 allows the user to view a search engine results page received from the search engine 140. In some embodiments, the search engine results page includes clusters for results based on tags that correspond to social network identifiers. The computer 120 is connected to the search engine 140 via network 110. The computer 120 is utilized by a user to generate search terms, to hover over objects, to select links or objects, and to receive search engine results pages or web pages that are relevant to the search terms, the selected links, or the selected objects. The computer 120 includes, without limitation, personal digital assistants, smart phones, laptops, personal computers, gaming systems, set-top boxes, or any other suitable client computing device. The computer 120 includes user and system information storage to store user and system information on the computer 120. The user information may include search histories, cookies, and passwords. The system information may include Internet Protocol addresses, cached web pages, and system utilization. The computer 120 communicates with the search engine 140 to receive the search results or web pages that are relevant to the search terms, the selected links, or the selected objects. The computer 120 may communicate with the entity graph 150 to receive data regarding an entity identified in the query. For instance, the data may include the number of hops a user that entered the query is from the entity; profiles associated with the searcher or entities having social network identifiers that match the query, when the query is classified as a name query; the documents that are tagged with an identifier corresponding to the entities that match the query; etc.

Accordingly, a searcher may utilize computer 120 to generate a query for “Ed Harris.” The searcher may submit the query to the search engine 140, which may classify the query as a name query. In turn, the search engine 140 locates entries in the index 130 that match the query. Concurrently, the search engine 140 accesses the entity graph 150 to identify entities that both match the query and are within the social network of the user. The search engine 140 retrieves the identified entities and documents that are tagged with identifiers that correspond to the identified entities from the entity graph 150. The search engine 140 combines the located entries and documents from the entity graph in a search engine results page. In one embodiment, the documents retrieved from the entity graph are clustered with an image or other identifier retrieved from the profiles of the identified entities.

In one embodiment, the search engine may utilize feedback received from searchers to prioritize placement of documents within the clusters for the entities. A tag that links the entity and the document may be associated with a confidence level that indicates the probability that a document is related to the entity. In some cases, the confidence level is 100% because (a) the entity specifies, via a feedback interface, that the document is related to it; (b) upon comparison with other documents associated with the entity, the document has a high similarity based on textual content, subject matter, authors, or other features; and (c) other users of the search engine have implicitly confirmed the document and corresponding tag by clicking on the document when it was returned in search results associated with the entity.

In other cases, the confidence level is less than 100% because others, including the search engine 140, have suggested that the document is related to the entity. When the confidence level is less than a threshold amount, e.g., 75%, the search engine 140 solicits feedback from a user searching for the entity. The feedback received is utilized to update the confidence. Positive feedback from the user may improve the confidence. Negative feedback may reduce the confidence. Accordingly, the search engine results page may include documents within the entity cluster that have a threshold level of confidence, e.g., 80%.

The index 130 stores words and a posting list. The words are typically associated with electronic documents like, web pages, videos, text files, and images. The posting list allows the search engine 140 to identify the documents associated with the words. In some embodiments, the index 130 also stores tags that correspond to social network identifiers for a plurality of entities in a social network. For instance, the tags are automatically included in the index based on an analysis of the content associated with URLs in each index entry. When a match is found between the social network identifier represented by the tag and the content, the tag may be included as a suggested tag. In other embodiments, the suggested tags may be stored in the entity graph 150. The tags may be utilized by the search engine 140 when responding to queries, like name queries, for URLs associated with an entity identified in the query.

The search engine 140 is utilized to traverse the index 130 and generate a search engine results page in response to a search request, including name queries. The search engine 140 is communicatively connected via network 110 to the computers 120. The search engine 140 is also connected to index 130 and the entity graph 150. In certain embodiments, the search engine 140 is a server device that generates graphical user interfaces for display on the computer 120. The search engine 140 receives, over network 110, selections of words or selections of links from computer 120 that renders the interfaces that receive interactions from users. In one embodiment, the interactions from the users also include feedback for suggested tags.

In certain embodiments, the search engine 140 includes a query classifier 142, an inference service 144, and a ranking engine 146. The query classifier 142 attempts to classify the query based on the search terms included in the query and social network data associated with a social network identifier of the user if one is available. The query may be classified in one or more categories: name, food, restaurant, nature, finance, business, etc. The query classifier 142 may use the metadata associated with the matching electronic documents located in the index 130 to classify the query. The metadata that represents the categories associated with the documents can be used to classify the respective query by counting how many times a category is identified as associated with a matching document returned by the index 130.

The inference service 144 may receive the query and classification associated with the query. The inference service 144 detects the social network identifier of the user. For instance, if the user is logged in to a social network account, the entity graph 150 for the entity is obtained by the inference service 144 when the entity has public profile or is within the social network for the user. In turn, the inference service 144 may identify additional documents that could be linked to the entity specified by the query. For instance, the entity graph may have a profile of the entity that is parsed by the inference service 144. The inference service 144 may extract two documents from the profile of the entity. The inference service 144 confirms that the two extracted documents are currently linked to the entity in the entity graph 150. In turn, the inference service 144 may identify a third document that is specified in each of the two documents. The inference service 144 determines whether the third document is currently linked to the entity. When the third document in not within the entity graph for the entity, the inference service 144 suggests including a tag that links the third document and the entity in the entity graph 150. In some embodiments, the suggested tag may include a qualifier such as authored by, mentioned in, interested in, etc. In turn, the suggested tag may be presented to friends of the entity identified in the social network, if the friends send a query to the search engine having the entity name.

The ranking engine 146 receives matching entries to the query from the index 130. When the social network identifier is available, the ranking engine 146 also receives additional documents from the entity graph 150 that includes currently tagged documents and suggested tags for additional documents. In turn, the ranking engine 146 removes duplicates and orders the entries and documents based on matches between the query and a confidence associated with a tag linking a document to the entity. In one embodiment, the ranking engine 146 may cluster the entries and documents based on the tags associated with the entity and a relationship (e.g., friend, colleague, family, etc.) between the user and entity.

When the social network identifier is unavailable, in some embodiments, the ranking engine 146 may be configured to order the entries based on the normal ranking function, like PageRank and others, that calculate, among other factors, term frequency within the content, number of in links and out links, and other features of the content, like date, author, last modification, etc., to assign a rank score. In other embodiments, when the query is classified as a name query, the ranking engine 146 may locate entries in the index 130 that match the name query. Additionally, the ranking engine 146 may obtain additional documents specified by tags and suggested tags associated with the entity in the entity graph. The documents or entries may be ordered based on similarity to the query and each other, or the confidence specified in the entity graph.

Accordingly, the search engine 140 may transmit the query to the index 130. The search engine 140 utilizes the query to identify URLs in the index 130 that match. In turn, the search engine 140 examines the matches and provides the computer 120 a set of uniform resource locators (URLs) that point to web pages, images, videos, or other electronic documents in the search engine results page. The search engine results page may include URLs or clusters of URLs in ranked order based on the classification assigned to the query, the availability of the social network identifier of the searcher, or social network identifiers and profiles for entities identified in the query.

The entity graph 150 receives requests for social network data and generates responses to the requests for social network data. The social network data includes user-profile data, like education, work, current location, hometown, friends, likes, and relationship status. The social network data includes an identifier, e.g., a numerical identifier, that corresponds to an entity's user name. The social network data includes tags and suggested tags. For instance, a social network identifier may be “Bart Smith,” the user name of an entity on the social network. The social network information, public or private, may be stored in a database accessible by the search engine 140. The social network data may also identify the friends of friends for a user and include the data available for the friends of friends. In some embodiments, the entity graph 150 is provided by a server device that is connected to network 110, index 130, and computer 120.

The entity graph 150, in some embodiments, includes nodes that represent documents or entities in a social network. The edges, in the entity graph 150, link documents and entities or entities and entities. Links between documents and entities are based on tags or suggested tags. The links between entities are based on connections included in the social network of the entity or the user that is searching for the entity. The entity graph 150 for suggested tags may include the confidence level. The entity graph 150 also specifies a qualifier for the tags and the suggested tags. The qualifiers may include author, actor, celebrity, politician, interested in, mentioned in, etc. The entity graph 150 may be stored in a database and updated periodically to include more suggested tags or to make suggested tags permanent based on the confidence level associated with the suggested tags.

Accordingly, the computing system 100 is configured with a search engine 140 that provides results that include URLs or clustered URLs. The search query generated by the computer 120 is received by the search engine 140, which traverses the index 130 and entity graph 150 to obtain results, including tagged results based on the social network identifier of the searcher or the social network identifier of the entity specified in the query. The search engine 140 transmits the results to the computer 120. In turn, the computer 120 renders the results for the searchers.

Embodiments of the invention increases the priority of electronic documents matching a query based on an entity graph linking documents and entities or based on social network data available for the searcher or friends of the searcher. The search engine receives a query from a searcher and determines whether a social network identifier is available for the searcher. When the social network identifier of the searcher is not provided by the searcher, the electronic documents are ranked based on the match to the query and public profiles matching the query and included in the entity graph. The entity graph includes suggested tags for the entity and documents associated with the entity. When the social network identifier is available, the electronic documents are ranked based on the similarity between the query and the entities in the graph and confidence levels associated with documents having suggested tags.

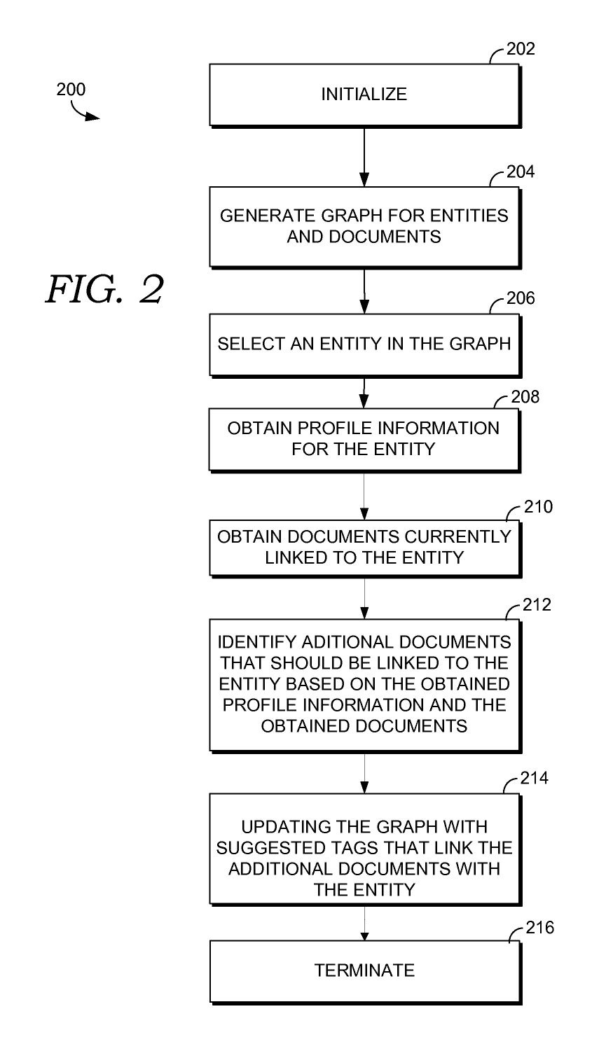

FIG. 2 is a logic diagram 200 illustrating an exemplary computer-implemented method for tagging documents, in accordance with embodiments of the invention. The method initializes in step 202. In step 204, a search engine may generate a graph having nodes and edges. The nodes represent entities and documents and the edges represent tags and relations. In one embodiment, the entities are in a social network and the documents are electronic content. The relations are connections that link entities in the social network. The tags are identifiers that link the documents to the entities. Each entity in the entity graph may have different identifiers.

The search engine selects an entity in the graph, in step 206. In turn, the search engine obtains profile information for the entity, in step 208. The profile information for the entity, in one embodiment, includes a name for the entity, a location for the entity, URLs that link to content of interest to the entity, or hobbies for the entity.

In step 210, the search engine obtains documents currently linked to the entity. In step 212, additional documents are identified by the search engine. The additional documents could be linked to the entity based on the obtained profile information and the obtained documents. The additional documents may be referenced in the profile or in the documents currently linked to the entity. The additional documents are compared, by the search engine, against the profile information of the entity to find matching information. The additional documents may also be compared against the linked documents or profile information of the user searching for the entity to find matching information. The additional documents are included, by the search engine, in the graph as a suggested tag when a match is found.

In step 214, the search engine may update the graph with suggested tags that link the additional documents with the entity. In turn, the search engine generates a search engine results page that displays the suggested tags to a user, in response to a search query having a name or an identifier associated with the selected entity. In certain embodiments, the search engine results page may include the additional documents that are linked to the suggested tag. Also, the search engine may display the documents currently linked to the entity and profile information for the entity in a cluster separate from the additional documents in the search engine results page. The method terminates in step 216.

In alternate embodiments of the invention, a search engine results page includes matching entries from the index and entity graph. The search engine results page may cluster the matches based on the similarity of the documents to the query, similarity of the documents to the profiles of the entity identified in the query, or similarity of the documents to other documents associated with the tags or suggested tags included in the entity graph. The tags and profile information may allow the search engine to disambiguate entities with similar names and to identify documents for disambiguated entities.

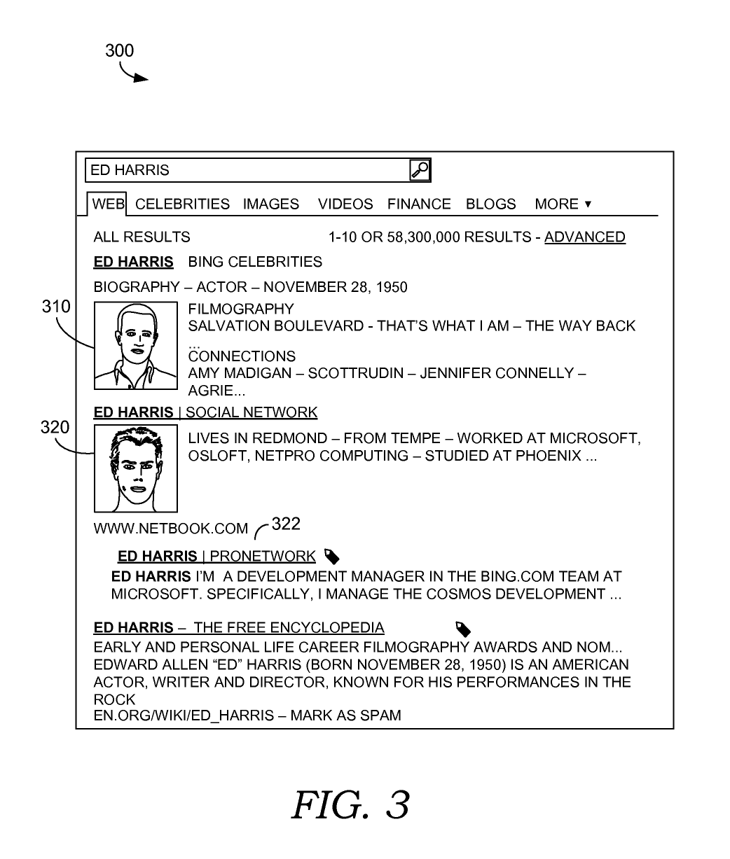

FIG. 3 is a graphical user interface illustrating electronic documents provided in a search engine results page 300, in accordance with embodiments of the invention. The search engine results page 300 includes URLs that match a query. For instance, the query for “ED HARRIS” returns two entities 310 or 320 with different profiles and results. The search engine may generate search engine results page 300 to display the related entities. The additional documents 322 that are linked via suggested tags or documents linked via tags may be displayed proximate to the associated entity 320. In some embodiments, the documents or additional documents are indented below the corresponding entity 310 or 320 identified by the tags or suggested tags.

The search engine results page generated by the search engine may include documents associated with suggested tags. In turn, the search engine may solicit feedback for the suggested tags from the user that entered the search query. The feedback may include an indication of whether the document is associated with the entity. In certain embodiments, feedback is requested from users that are friends of or have some relationship with the entity associated with the documents.

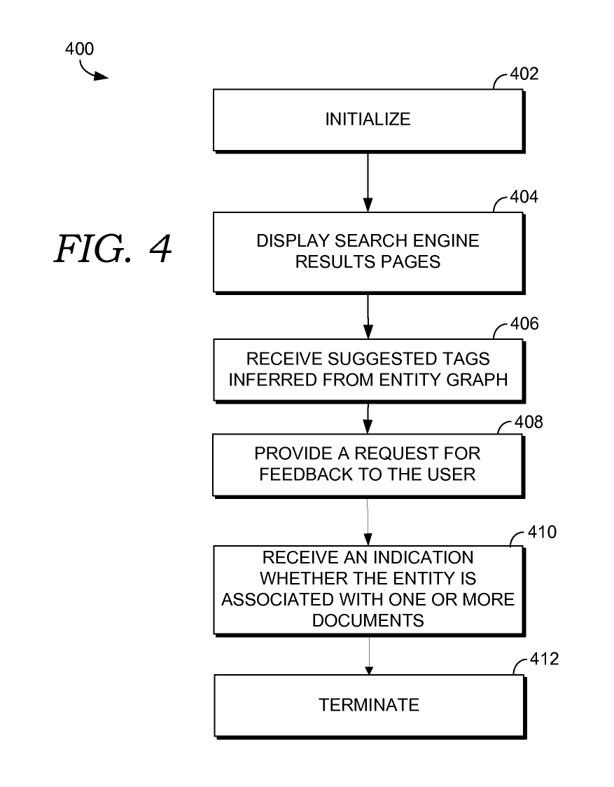

FIG. 4 is another logic diagram illustrating an exemplary computer-implemented method for tagging electronic documents, in accordance with embodiments of the invention. In step 402, the method initializes. In step 404, the computing device displays a search engine results page in response to a user query for an entity. In step 406, the computing device receives suggested tags associated with the entity. In turn, the user may receive a request for feedback, in step 408. The feedback may confirm whether one or more documents corresponding to the suggested tags are associated with the entity. In step 410, the computing device receives an indication, from the user, regarding whether the entity is associated with the one or more documents. The search engine results page is reranked by the search engine to reflect the suggested tags for the entity and transmitted to the computing device for display. In some embodiments, the suggested tag becomes permanent in a graph for the entity based on the feedback received from the user. The feedback may be collected continually and indefinitely to determine the confidence level during different periods of time. Optionally, when the confidence level associated with the suggested tag is above 80%, the suggested tag becomes a permanent tag and feedback may no longer be collected for the tag. In other embodiments, the tag may be removed based on feedback from the entity that the suggested tag is associated with. The method terminates in step 412.

In some embodiments, the computer system is configured to tag documents. The computer system may include a database and search engine. The database stores a graph having edges connecting documents and entities. The graph is updated periodically to include suggested tags based on profile information associated with the entities or feedback received from a user. The suggested tags identify additional documents that correspond to an entity. The search engine provides search engine results page to a user in response to a user query. The search engine receives feedback from the user regarding the suggested tags and the feedback indicates whether the documents that correspond to the suggested tags are related to an entity identified in the query. The search engine, also, updates the search engine results page based on feedback on the suggested tags received from the database.

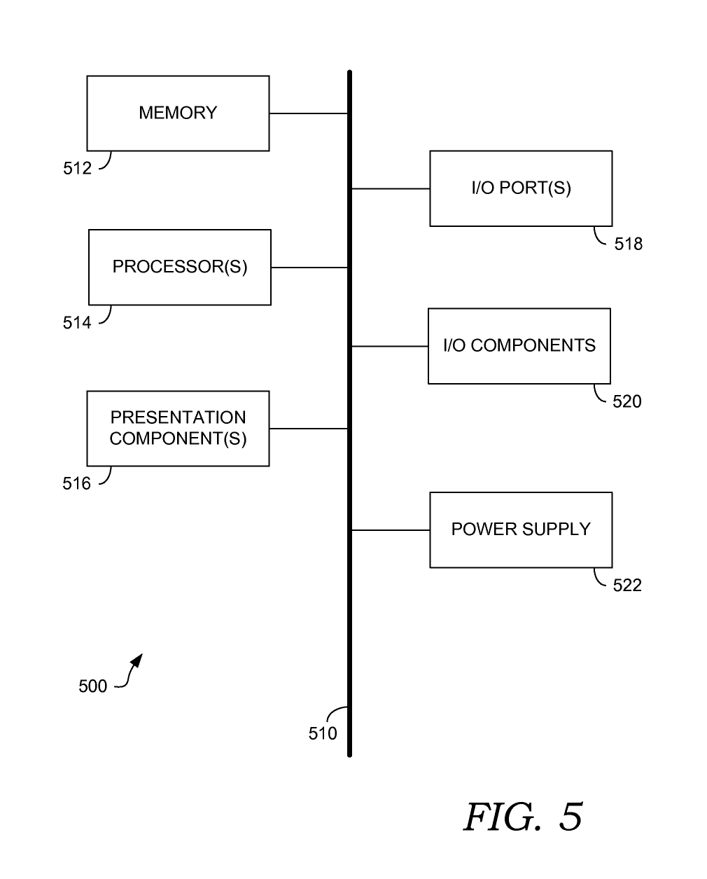

FIG. 5 is a component diagram illustrating an exemplary operating environment, in accordance with embodiments of the invention. Having briefly described an overview of the embodiments of the invention, an exemplary operating environment in which various aspects of the invention may be implemented is now described. Referring to the drawings generally, and initially to FIG. 5 in particular, an exemplary operating environment for implementing embodiments of the invention is shown and designated generally as computing device 500. Computing device 500 is but one example of a suitable computing environment and is not intended to suggest any limitation as to the scope of use or functionality of the invention. Neither should the computing device 500 be interpreted as having any dependency or requirement relating to any one or combination of components illustrated.

The embodiments of the invention may be described in the specialized context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including handheld devices, consumer electronics, general-purpose computers, more specialty computing devices, etc. The embodiments of the invention may also be practiced in distributed computing environments where tasks are performed by remote-processing devices that are linked through a communications network.

With continued reference to FIG. 5, computing device 500 includes a bus 510 that directly or indirectly couples the following devices: memory 512, one or more processors 514, one or more presentation components 516, input/output ports 518, input/output components 520, and an illustrative power supply 522. Bus 510 represents what may be one or more busses (such as an address bus, data bus, or combination thereof). Although the various blocks of FIG. 5 are shown with lines for the sake of clarity, in reality, delineating various components is not so clear, and metaphorically, the lines would more accurately be grey and fuzzy. For example, one may consider a presentation component such as a display device to be an I/O component. Additionally, many processors have memory. The inventor hereof recognizes that such is the nature of the art, and reiterates that the diagram of FIG. 5 is merely illustrative of an exemplary computing device that can be used in connection with one or more embodiments of the present invention. Distinction is not made between such categories as “workstation,” “server,” “laptop,” “handheld device,” etc., as all are contemplated within the scope of FIG. 5 and reference to “computing device.”

Computing device 500 typically includes a variety of computer-readable media. Computer-readable media can be any available media that can be accessed by computing device 500 and includes both volatile and nonvolatile media, removable and nonremovable media. By way of example, and not limitation, computer-readable media may comprise computer storage media and communication media. Computer storage media includes volatile and nonvolatile, removable and nonremovable media implemented in any method or technology for storage of information such as computer-readable instructions, data structures, program modules, or other data. Computer storage media includes, but is not limited to, Random Access Memory (RAM), Read Only Memory (ROM), Electronically Erasable Programmable Read Only Memory (EEPROM), flash memory or other memory technology, CD-ROM, digital versatile disks (DVD) or other holographic memory, magnetic cassettes, magnetic tape, magnetic disk storage or other magnetic storage devices, carrier wave, or any other medium that can be used to encode desired information and which can be accessed by the computing device 500.

Memory 512 includes computer-storage media in the form of volatile and/or nonvolatile memory. The memory may be removable, nonremovable, or a combination thereof. Exemplary hardware devices include solid-state memory, hard drives, optical-disc drives, etc. Computing device 500 includes one or more processors that read data from various entities such as the memory 512 or the I/O components 520. The presentation component(s) 516 present data indications to a user or other device. Exemplary presentation components include a display device, speaker, printing component, vibrating component, etc.

I/O ports 518 allow the computing device 500 to be logically coupled to other devices including the I/O components 520, some of which may be built in. Illustrative components include a microphone, joystick, game pad, satellite dish, scanner, printer, wireless device, etc.

Embodiments of the invention work to best exploit the information that can be received from a social networking provider to reliably identify results for individuals who have a predefined type of relationship with a searcher. In certain embodiments, a search engine identifies ambiguous entity names and documents associated with the entity names via the entity graph. The search engine disambiguates the entity names using the social context of a user that searches for the entity and feedback from individuals in the social network of the entity. The query received from a user may cause the search engine to locate documents that have information matching profile data for the network entity and documents that match the query. In some embodiments, the documents are also linked to the entity in the entity graph based on suggested tags inferred by the search engine or tags previously received from the entity or other users.

Social network information for the user and closeness of the user to the entity may be used to select a confidence level attributed to feedback obtained from the user. For instance, the search engine may determine the matches between profiles for the user and entity aid in identifying closeness between the entity and user in addition to a type of connection: friend, colleague, student, etc. The profiles of the user or entity may also be utilized by the search engine to determine whether suggested tags could be associated with the entity and whether the suggested tags could be provided to the user for feedback. Matches between the documents linked via the suggested tags and profiles of the user or entity may indicate that the suggested tag is appropriate for the entity or appropriate for display to the user to obtain feedback. The feedback may be received from multiple users and utilized to rerank the document that is subject to the feedback.

The graph, in one embodiment, may be updated to replace a suggested tag with a permanent tag based on the received feedback. The graph may include suggested tags for a document not currently linked to an entity but that matches the information in the entity's profile information, including an entity identifier, like name. The tags may include identifiers like author, friends, and colleague.

For example, Ed Harris's social network profile has links to a university and links to webpages about him. The search engine may parse the profile information, and links to webpages, to locate additional documents like a resume that is linked to his profile and a research paper on the university webpage. In turn, the search engine may suggest updates to the entity graph of Ed Harris to include suggested tags that link a node representing the entity Ed Harris to the resume and research paper. These suggested links may be presented to the entity or user connected to the entity when a query having the name of the entity is received. The search engine may receive confirmation from the entity or any other person in the social network of the entity that the suggested tags are correct.

In certain embodiments, when the search engine is creating the relationship between the entity and the document, the entity graph is updated without obtaining confirmation from individuals in the entity's social network. In other embodiments, once a primary document is confirmed as corresponding to the entity, other secondary documents that are linked to the confirmed primary document may obtain confirmation via proxy. The user or entity may be presented with linked secondary documents when providing feedback on the primary document.

The search engine is configured to display the results and identifiers associated with a name included in the query. The results may cluster documents that are linked in the entity graph with each of the identifiers. The documents may be ranked based on the confidence level included in the entity graph. Accordingly, embodiments of the invention may provide conflict resolution when one or more documents are associated with different entities having the same name.

Additionally, celebrities on a social network may receive many suggested tags. For celebrities and other public figures, feedback on suggested tags may be received from any person that provided the search engine with a query having the name of the celebrity or public figure. The invention reduces spam in the entity graph for the celebrity or public figure by requiring a large level of confidence, e.g. 95%, before the suggested content, not identified by the celebrity or public figure, is included in the entity graph of the celebrity or public figure.

The embodiments of the invention have been described in relation to particular embodiments, which are intended in all respects to be illustrative rather than restrictive. Alternative embodiments will become apparent to those of ordinary skill in the art to which the present invention pertains without departing from its scope. From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

The technology claimed is:

1. A computer-implemented method to tag documents, the method comprising:
generating a graph having nodes and edges, wherein the nodes represent entities and documents and the edges represent tags and relations;
selecting an entity in the graph;
obtaining profile information for the entity;
obtaining the documents that are linked to the entity;
identifying additional documents that could be linked to the entity based on the obtained profile information and the obtained documents; and
updating the graph with suggested tags that link the additional documents with the entity.

2. The computer-implemented method of claim 1, wherein the entities are in a social network and the documents are electronic content.

3. The computer-implemented method of claim 2, wherein the relations are connections that link entities in the social network.

4. The computer-implemented method of claim 1, wherein the tags are identifiers that link the documents and entities.

5. The computer-implemented method of claim 4, wherein each entity has a different identifier.

6. The computer-implemented method of claim 1, wherein the profile information for the entity includes a name for the entity, a location for the entity, URLs that link to content of interest to the entity, or hobbies for the entity.

7. The computer-implemented method of claim 1, wherein the additional documents may be referenced in the profile or in the documents currently linked to the entity.

8. The computer-implemented method of claim 1, wherein the additional documents are compared against the profile information to find matching information.

9. The computer-implemented method of claim 8, wherein the additional documents are compared against the linked documents to find matching information.

10. The computer-implemented method of claim 9, wherein the additional documents are compared against the profile information of a searcher to find matching information.

11. The computer-implemented method of claim 10, wherein the additional documents are included in the graph when a match is found.

12. The computer-implemented method of claim 1, further comprising: displaying the suggested tags to a user, in response to a search query having a name or an identifier associated with the selected entity.

13. The computer-implemented method of claim 12, further comprising: displaying the additional documents that are linked to the suggested tag.

14. The computer-implemented method of claim 12, further comprising: displaying the documents currently linked to the entity and profile information for the entity in a cluster separate from the additional documents.

15. One or more computer-readable media having computer-executable instructions embodied thereon for performing a method to tag documents, the method comprising:
displaying, by one or more computing devices, a search engine results page in response to a user query for an entity;
receiving, by one or more computing devices, suggested tags associated with the entity;
providing request for feedback to the user, wherein the feedback confirms whether one or more documents corresponding to the suggested tags are associated with the entity; and
receiving an indication from the user whether the entity is associated with the one or more documents.

16. The media of claim 15, wherein the suggested tag becomes permanent in a graph for the entity based on the feedback received from the user.

17. The media of claim 15, wherein a search engine results page is re-ranked to reflect the suggested tags for the entity.

18. A computer system for tagging documents, the computer system comprising:
a database storing a graph having edges connecting documents and entities, wherein the graph is updated periodically to include suggested tags based on profile information associated with the entities; and
a search engine configured to provide search engine results page in response to a query and to update the search engine results page based on the suggested tags received from the database.

19. The system of claim 18, wherein the suggested tags identify additional documents that correspond to an entity.

20. The system of claim 19, wherein the search engine receives feedback from the user regarding the suggested tags and the feedback indicates whether the documents that correspond to the suggested tags are related to an entity identified in the query.
